(19) United States
(12) Patent Application Publication
(10) Pub. No.: US 2004/0105435 A1
(43) Pub. Date: Jun. 3, 2004

(54) Communication port management apparatus and method thereof

(75) Inventor: Yoshihide Morioka, Tokyo (JP)

Correspondence Address: OLIFF & BERRIDGE, PLC, P.O. BOX 19928, ALEXANDRIA, VA, 22320, US

(73) Assignee: ALLIED TELESIS K.K., Tokyo (JP)

(21) Appl. No.: 10/465,886

(22) Filed: Jun. 20, 2003

(30) Foreign Application Priority Data
Nov. 28, 2002 (WO) PCT/JP02/12449

(51) Int. Cl. H04L 12/50

(52) U.S. Cl. 370/359

(57) ABSTRACT

An SNMP program actuated on a computer successively inquires of network devices about their settings and statuses. Each of the network devices having received such an inquiry returns the status and setting of each port in response to the inquiry from the computer (SNMP program). The computer (SNMP program), every time a reply is returned from a network device, determines whether or not there is any inconsistency between the status and the setting of any port, and sets the network device containing the port to disable the port if a status-setting inconsistency has been detected.

### BACKGROUND OF THE INVENTION

1. Field of the Invention

The present invention relates to a communication port management apparatus and method thereof for managing communication ports in a communication device.

2. Description of the Prior Art

A network device such as a router has communication ports (hereinafter sometimes referred to as simply ports) for connecting communication cables.

Each port can be set for enable/disable, and can take on a communication enabled/disabled status.

Whereas the user usually sets the ports for enable/disable of these alternatives, there is no definite rule as to the initial setting at the time the device is shipped out by its manufacturer.

For instance, if any port to which nothing is connected remains in the initial enable setting without being set otherwise by the user and the network continues to be operated, this port may be used by any unauthorized third party or used in a wrong way.

For instance, Patent References 1 through 4 disclose methods for network management according to an SNMP Protocol by taking note of the ports of network devices.

However, none of these products of the prior art proposes a solution to the above-noted troubles that may arise from leaving any unused port in an enabled status.

[Patent Reference 1] Japanese published unexamined patent application 2002-190819

[Patent Reference 2] Japanese published unexamined patent application 2002-101125

[Patent Reference 3] Japanese published unexamined patent application 2002-101125

[Patent Reference 4] Japanese published unexamined patent application 2000-201165

### SUMMARY OF THE INVENTION

An object of the present invention, attempted in view of the problem, is to provide a communication port management apparatus and method thereof for managing ports in network devices.

Another object of the invention is to provide a communication port management apparatus and method thereof capable of effectively preventing any trouble due to leaving any unused port in a network device in an enabled status.

[Communication Port Management Apparatus]

In order to achieve the objects stated above, a communication port management apparatus according to the invention for managing each of one or more communication ports which each of one or more communication units has comprises information acquiring means for acquiring from each of the communication units first setting information indicating a setting for each of the communication ports and first status information indicating a status of each of the communication ports, or first communication unit information containing either of the foregoing, information holding means for holding second setting information indicating a setting for each of the communication ports and first status information (second status information) contained in the acquired first communication unit information, or second communication unit information containing either of the foregoing, and communication port managing means for managing each of the communication ports to be enabled or disabled on the basis of the acquired first communication unit information and the held the second communication unit information.

Preferably, the first communication unit information should include at least the first setting information, and the second communication unit information should include at least the second setting information; the information acquiring means should acquire from each of the communication units at least the first setting information; the information holding means should hold at least the second setting information; and the communication port managing means should disable any communication port on which the acquired first setting information and the held second setting information are inconsistent with each other.

Preferably, the first setting information and the second setting information should indicate whether each the communication port is enabled or disabled; and the communication port managing means should disable any communication port on which the acquired first setting information and the held second setting information are inconsistent with each other.

Preferably, the communication port managing means should disable any communication port on which the acquired first setting information indicates enable and the held first setting information indicates disable.

Preferably, the first communication unit information should include at least the first status information, and the second communication unit information should include at least the second status information; the information acquiring means should acquire the first status information from each of the communication units; the information holding means should successively hold at least the acquired first status information as the second status information; and the communication port managing means should manage each of the communication ports to be enabled or disabled on the basis of variation over time of the second status information.

Preferably, the first status information and the second status information should indicate a status of use of each of the communication ports; and the communication port managing means should disable any communication port on which the second status information inappropriately varies.

Preferably, statuses which can be indicated by the first status information and the second status information should include a first status indicating that the communication ports are enabled, a second status indicating that the communication ports are disabled, and a third status indicating that the communication ports are being tested; and the communication port managing means should disable any communication port on which the second status information indicates an inappropriate transition among the first through third statuses.

Preferably, the first communication unit information should include the first setting information and the first status information, and the second communication unit information should include at least the second status information; the information acquiring means should acquire the first setting information and the first status information from each of the communication units; the information holding means should successively hold at least the acquired first status information as the second status information; and the communication port managing means should manage each of the communication ports to be enabled or disabled on the basis of variation over time of the acquired first setting information and the second status information.

Preferably, statuses which can be indicated by the first status information and the second status information should include a first status indicating that the communication ports are enabled, a second status indicating that the communication ports are disabled, and a third status indicating that the communication ports are being tested; and the communication port managing means should disable any communication port on which the second status information indicates its being in the second or third status for a prescribed length of time or longer.

Preferably, at least the first communication unit information, the acquisition of the first communication unit information by the information acquiring means, and the management of communication ports by the communication port managing means should conform to the Simple Network Management Protocol (SNMP).

[Description of Communication Port Management Apparatus]

A communication port management apparatus according to the present invention will be briefly described below by way of an example.

Incidentally, the example shown below is intended to contribute to better understanding of the invention by describing it in more specific terms, but not to limit the technical scope thereof.

The communication port management apparatus according to the invention is connected to network devices (communication units) such as routers and switches, and manages each of the ports to be used for connection with a personal computer or a server in accordance with the Simple Network Management Protocol (SNMP).

In the database (information holding means) of the communication port management apparatus is stored in advance information (second setting information) according to which each of the ports of each network device (communication unit) is enabled or disabled for communication.

The information acquiring means, for instance if it detects at regular time intervals any alteration made in the network configuration in accordance with SNMP, issues an inquiry to each of the network devices (communication units).

On the network device (communication unit) is at work an SNMP agent, and the SNMP agent, in response to an inquiry from the communication port management apparatus, returns information on the actual setting (enable/disable or the like; first setting information) of each port and information on the status (enabled/disabled or the like; first status information) of each port to the communication port management apparatus.

The communication port management apparatus causes, out of the settings and statuses (first communication unit information) of ports returned from each network device (communication unit), at least the latter (second status information) to be successively stored into the database (information holding means).

The communication port managing means, if any port fits, for instance, either of (1) and (2) below, sets the pertinent network device (communication unit) to disable that port.

(1) Inconsistency in Setting:

Any port on which setting information returned from the pertinent network device (communication unit) indicates enable in spite of the corresponding information stored in the database (information holding means) indicating disable.

(2) Inconsistency Between Setting And Status:

Any port on which status information returned from the pertinent network device (communication unit) indicates being disabled or tested in spite of the pertinent port setting stored in the database (information holding means) indicating enable.

(3) Unstable Status:

Any port on which status information stored over time in the database (information holding means) indicates inappropriate or unstable variation, suggesting possible port trouble or illegitimate use by a third party.

(4) User-Defined Disable:

Otherwise, the setting and status returned from any network device (communication unit) constitute a combination defined in advance with the setting and status stored in the database (information holding means).

[Communication Port Management Method]

A communication port management method according to the present invention for managing each of one or more communication ports which each of one or more communication units has, whereby first setting information indicating a setting for each of the communication ports and first status information indicating a status of each of the communication ports, or first communication unit information containing either of the foregoing is acquired from each of the communication units; whereby second setting information indicating a setting for each of the communication ports and first status information (second status information) contained in the acquired first communication unit information, or second communication unit information containing either of the foregoing is held; and whereby each of the communication ports is managed to be enabled or disabled on the basis of the acquired first communication unit information and the held second communication unit information.

Preferably, the first communication unit information should include at least the first setting information, and the second communication unit information should include at least the second setting information; at least the first setting information should be acquired from each of the communication units; at least the second setting information should be held; and any communication port on which the acquired first setting information and the held second setting information are inconsistent with each other should be disabled.

Preferably, the first communication unit information should include at least the first status information, and the second communication unit information should include at least the second status information; the first status information should be acquired from each of the communication units; at least the acquired first status information should be successively held as the second status information; and each of the communication ports should be managed to be enabled or disabled on the basis of variation over time of the second status information.

Preferably, the first communication unit information should include the first setting information, and the first status information and the second communication unit information should include at least the second status information; the first setting information and the first status information should be acquired from each of the communication units; at least the acquired first status information should be successively held as the second status information; and each of the communication ports should be managed to be enabled or disabled on the basis of variation over time of the acquired first setting information and the second status information.

[Program]

Further a program according to the present invention for managing each of one or more communication ports which each of one or more communication units has, the program causing a computer to execute a step of acquiring first setting information indicating a setting for each of the communication ports, and first status information indicating a status of each of the communication ports, or first communication unit information containing either of the foregoing, from each of the communication units; a step of holding second setting information indicating a setting for each of the communication ports, and first status information (second status information) contained in the acquired first communication unit information, or second communication unit information containing either of the foregoing; and a step of managing each of the communication ports to be enabled or disabled on the basis of the acquired first communication unit information and the held second communication unit information.

Preferably, the first communication unit information should include at least the first setting information, and the second communication unit information should include at least the second setting information; at least the first setting information should be acquired from each of the communication units at the step of acquiring the first communication unit information; at least the second setting information should be held at the step of holding the second communication unit information; and any communication port on which the acquired first setting information and the held second setting information are inconsistent with each other should be disabled at the step of managing each of the communication ports to be enabled or disabled.

Preferably, the first communication unit information should include at least the first setting information, and the second communication unit information should include at least the second setting information; the first status information should be acquired from each of the communication units at the step of acquiring the first communication unit information; at least the acquired first status information should be successively held as the second status information at the step of holding the second communication unit information; and each of the communication ports should be managed to be enabled or disabled on the basis of variation over time of the second status information at the step of managing each of the communication ports to be enabled or disabled.

Preferably, the first communication unit information should include at least the first setting information, and the second communication unit information should include at least the second setting information; the first setting information and the first status information should be acquired from each of the communication units at the step of acquiring the first communication unit information; at least the acquired first status information should be successively held as the second status information at the step of holding the second communication unit information; and each of the communication ports should be managed to be enabled or disabled on the basis of variation over time of the acquired first setting information and the second status information at the step of managing each of the communication ports to be enabled or disabled.

### BRIEF DESCRIPTION OF THE DRAWINGS

FIG. 1 illustrates the configuration of a network system 1 to which a communication port management method according to the present invention is adapted;

FIG. 2 illustrates an example of configuration of one of network devices 2 shown in FIG. 1;

FIG. 3 illustrates the configuration of a computer 12 for network management shown in FIG. 1;

FIG. 4 illustrates the configuration of an SNMP program 3 to be executed by the computer 12 shown in FIG. 1 and FIG. 3;

FIG. 5 is a flowchart showing processing (S20) by a port setting section 322 of the SNMP program 3 shown in FIG. 4;

FIG. 6 illustrates a normal sequence (S10) when the setting-status of a port 26 is normal in the network system 1 shown in FIG. 1; and

FIG. 7 illustrates an abnormal sequence (S14) when any abnormality has arisen in the setting-status of any of the ports 26 in the network system 1 shown in FIG. 1.

### DESCRIPTION OF THE PREFERRED EMBODIMENTS

Preferred embodiments of the present invention will be described in detail below.

[Network System 1]

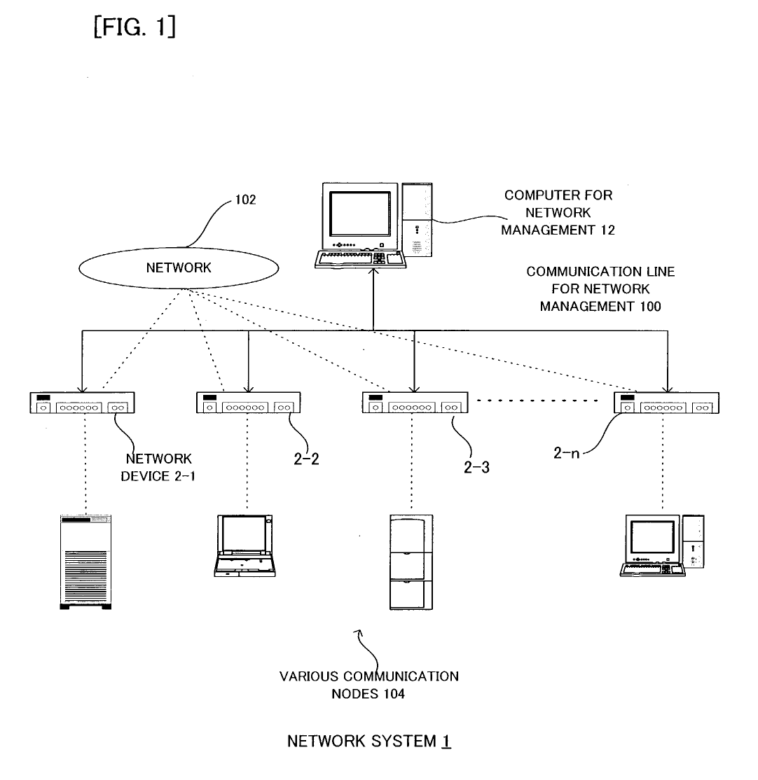

FIG. 1 illustrates the configuration of a network system 1 to which a communication port management method according to the invention is adapted.

As shown in FIG. 1, the network system 1 has a configuration in which one or more network devices 2-1 through 2-n (n ? 1) such as a hub, a router, a switch or the like, are connected to a computer 12 for network management via a communication line 100 for network management.

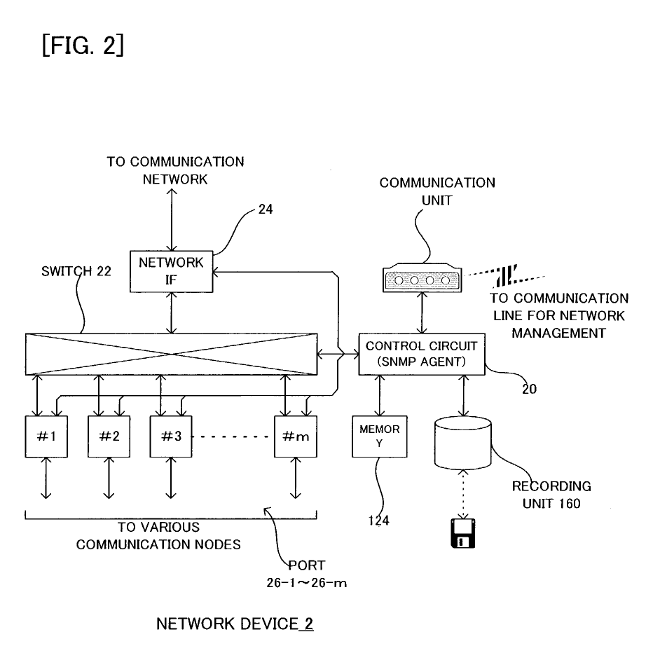

To add, each of the network devices 2-1 through 2-n has one or more communication ports 26-1 through 26-m (m ? 1; to be elaborated upon afterwards with reference to FIG. 2), and to each of these ports is connected one or another of various communication nodes 104 such as a computer, a server or the like. The communication nodes 104 perform data communication with a network 102 such as a LAN or the Internet via the network devices 2-1 through 2-m.

In the following description, when an unspecified items is indicated of any constituent parts which may be provided in a plurality, such as the network devices 2-1 through 2-m, it may be referred to simply as a (the) network device 2 or the like.

[Network Device 2]

FIG. 2 illustrates an example of configuration of one of the network devices 2 shown in FIG. 1.

As shown in FIG. 2, the network device 2 maybe, for instance, a switching hub unit configured of a control circuit 20 comprising a CPU and peripheral circuits thereto, a memory 124, a recording unit 160, a communication unit 140, a switch 22, a network interface (network IF) 24, and the ports 26-1 through 26-m.

[Control Circuit 20]

In the network device 2, the control circuit 20 carries out communication control over the switch 22 and the network IF 24 and the ports 26-1 through 26-m by executing a program for communication control (not shown) supplied via a recording medium or the like.

Also, the control circuit 20 provides the computer 12 (FIG. 1) with an SNMP agent function based on a Management Information Base (MIB), defined by RFC1213, by executing a Simple Network Management Protocol (SNMP) agent program similarly supplied via a recording medium or the like.

More specifically, the control circuit provides 20 the computer 12 (FIG. 1) with the following functions.

When an inquiry about the setting of each of the ports 26-1 through 26-m is received from the computer 12, the control circuit 20, in response to this inquiry, references the setting of each of the ports 26-1 through 26-m−1 and 26-m, and returns to the computer 12 setting information (first setting information) regarding each of them, indicating whether it is set for enable (ifAdminStatus=UP) or for disable (ifAdminStatus=DOWN).

Or, when an inquiry about the status of each of the ports 26-1 through 26-m is received from the computer 12 (FIG. 1) the control circuit 20, in response to this inquiry, references the status of each the ports 26-1 through 26-m−1 and 26-m, and returns to the computer 12 status information (second setting information) regarding each of them, indicating whether it is in an enabled status (ifoperStatus=UP), a disabled status (ifOperStatus=DOWN), or a testing state (ifAdminStatus=TEST)

However, information to be returned from the network device 2 to the computer 12 for controlling the ports 26 can be retuned or discarded as required.

That is to say, from the network device 2, both or either of setting information and status information, or any other item of information added to both of them may be returned to the computer 12.

Further, when the computer 12 (FIG. 1) instructs setting of each of the ports 26-1 through 26-m, the control circuit 20 sets each of the ports 26-1 through 26-m−1 and 26-m either for enable (ifAdminStatus=UP) or for disable (ifAdminStatus=DOWN) as instructed.

[Computer 12]

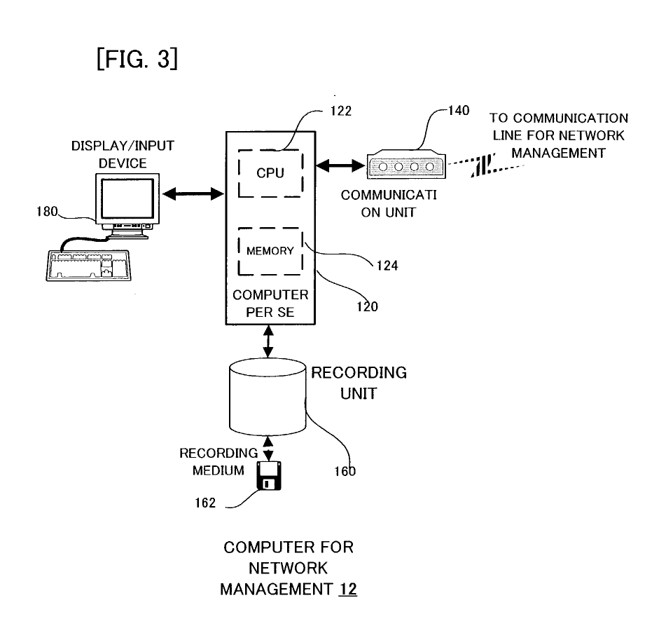

FIG. 3 illustrates the configuration of the computer 12 for network management as shown in FIG. 1.

As shown in FIG. 3, the computer 12 is composed of a computer per se 120 comprising a CPU 122, the memory 124 and circuits peripheral thereto, the communication unit 140 for performing communication with the network devices 2, the recording unit 160 which may be a CD device on an HDD, and a display/input unit 180 comprising a display device and a keyboard.

Thus the computer 12 contains constituent parts of a usual computer which permit communication with the network devices 2.

[SNMP Program 3]

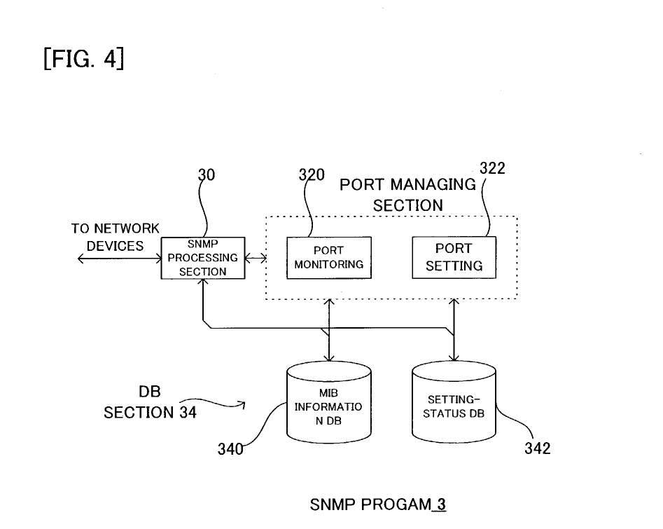

FIG. 4 illustrates the configuration of an SNMP program 3 to be executed by the computer 12 shown in FIG. 1 and FIG. 3.

As shown in FIG. 4, the SNMP program 3 is composed of an SNMP processing section 30, a port managing section 32 comprising a port monitoring section 320 (information acquiring means) and a port setting section 322 (communication port managing means), and a DB section 34 (information holding means) comprising an MIB information database (MIB information DB) 340 and a setting-status DB 342.

The SNMP program 3 is supplied to the computer 12 from, for instance, a recording medium 162 (FIG. 2), and loaded onto the memory 124 for execution to perform SNMP-based network management on each of the network devices 2.

The SNMP program 3 also manages the ports 26 of each of the network devices 2 (FIG. 1 and FIG. 2).

Thus the SNMP program 3 inquires of each of the network devices 2 the setting and status of each of its ports 26 and, on the basis of the response to this inquiry, causes each of the network devices 2 to disable any port 26 which is inappropriately set.

In the SNMP program 3, the SNMP processing section 30 performs SNMP-based network management on each of the network devices 2 (FIG. 1 and FIG. 2).

The MIB information DB 340 of the DB section 34 stores various settings for each of the ports 26 of each of the network devices 2-1 through 2-n (FIG. 1 and FIG. 2) to make them available for use by the port managing section 32.

The settings stored in the MIB information DB 340 include the enable/disable setting (ifAdminStatus=UP/DOWN) for each of the ports 26.

The setting-status DB 342, if there is setting information in the responses from the network devices 2 (FIG. 1 and FIG. 2), stores setting information (second setting information) on each of the ports 26 returned from each of the network devices 2 to make it available for use by the port managing section 32.

Or, the setting-status DB 342, if there is status information in the responses from the network devices 2, successively stores status information (second status information) on each of the ports 26 returned from each of the network devices 2 to make it available for use by the port managing section 32 as information representing the status over time of each of the ports 26.

The statuses stored in the setting-status DB 342 include the enable/disable/test setting (ifOperStatus=UP/DOWN/TEST) of each of the aforementioned ports 26 (FIG. 2).

As is information returned from any of the network devices 2 to the computer 12 (FIG. 1), information stored in the NIB information DB 340 and the setting-status DB 342 for use in port management can be retuned or discarded as required.

Therefore, according to the processing need, both setting information and status information or any other item of information added to both of them are stored into the DB section 34.

The port monitoring section 320 of the port managing section 32 periodically inquires of each of the network devices 2-1 through 2-n (FIG. 1 and FIG. 2), via the SNMP processing section 30, the setting and status of each of the ports 26-1 through 26-m, e.g. once a day, or when any alteration in the configuration of the network system 1 has been detected, and receives replies returned from the network devices 2-1 through 2-n in response to the inquiry.

Further, the port monitoring section 320 causes the setting-status DB 342 to store setting information and status information on each of the ports 26-1 through 26-m contained in the reply from each of the network devices 2-1 through 2-n.

[Port Setting Section 322]

The port setting section 322, if responses are received from the network devices 2 via the SNMP processing section 30, references information stored in the MIB information DB 340 and the setting-status DB 342, and performs management of each of the ports 26 (FIG. 2) of the network devices 2 via the SNMP processing section 30.

More specifically, the port setting section 322 disables any port 26 (FIG. 2) meeting any of the following conditions (1) through (4).

(1) Inconsistency In Setting:

Any port 26 on which setting information returned from a network device 2 indicates enable (ifAdminStatus=UP) in spite of the pertinent information stored in the MIB information DB 340 indicating disable (ifAdminStatus=DOWN) (for fear of illegitimate use by a third party).

(2) Inconsistency Between Setting and Status:

Any port 26 on which status information over time stored in the setting-status DB 342 indicates being disabled or tested (ifoperStatus=DOWN/TEST) for at least a prescribed length of time in spite of the pertinent port setting stored in the MIB information DB 340 indicating enable (ifAdminStatus=UP) (for fear of hardware trouble).

(3) Unstable Status:

Any port 26 on which status information stored over time in the setting-status DB 342 indicates inappropriate or unstable variation such as intermittent transition between communication enabled, disabled and tested (ifoperstatus=UP/DOWN/TEST) (for fear of port trouble or illegitimate use by a third party).

(4) User-Defined Disable:

The setting and status, respectively indicated by setting information and status information, returned from any network device 2, constitute a combination defined in advance by the user by means of setting information and status information stored in the MIB information DB 340 and the setting-status DB 342.

In addition, the port setting section 322 can appropriately select a condition or conditions as required out of (1) through (4) above, under which any port 26 is to be disabled, and further prescribe, besides the four conditions, some other condition or conditions to disable ports 26.

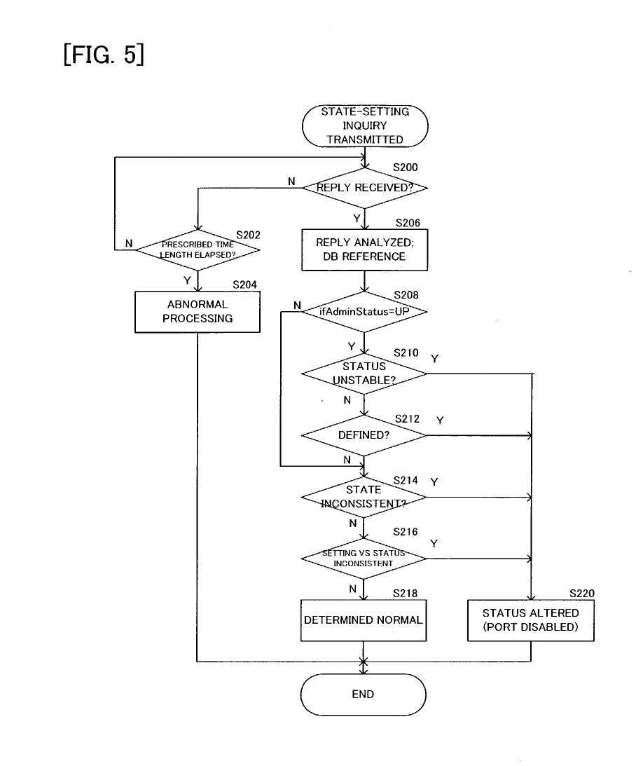

Processing by the port setting section 322 and other constituent parts of the SNMP program 3 will now be further described with reference to FIG. 5.

FIG. 5 is a flowchart showing processing (S20) by the port setting section 322 of the SNMP program 3 shown in FIG. 4.

As shown in FIG. 5, the port monitoring section 320 successively transmits inquiries about the status and setting to each of the network devices 2 via the SNMP processing section 30.

At step 200 (S200), the port monitoring section 320 determines whether or not a response has been received from any of the network devices 2 (FIG. 1 and FIG. 2) of which the status and/or setting was inquired via the SNMP processing section 30.

If a response has been received from any network device 2, the SNMP program 3 goes ahead to processing of S206, and in any other case, to processing of S206.

At step 202 (S202), the port monitoring section 320 determines whether or not a prescribed length of time has passed in a state in which no response has come from any of the network devices 2.

If the prescribed length of time has passed in this state, the SNMP program 3 goes ahead to processing of S204, and in any other case, goes back to processing of S200.

At step 204 (S204), the SNMP program 3 performs abnormality processing for the network device or devices 2 failing to respond, and ends processing.

At step 206 (S206), the port monitoring section 320 analyzes each response received, and causes the MIB information DB 340 and the setting-status DB 342 to store necessary information.

Further, the control circuit 20 notifies the port setting section 322 of each responding network device 2.

The port setting section 322 references the MIB information DB 340 and the setting-status DB 342 to acquire necessary information for managing the ports 26 of each network device 2 which has responded and has thereby become subject to management.

At step 208 (S208), the port setting section 322 determines whether or not the setting for each manageable port 26 is enable (ifAdminStatus=UP) in the MIB information DB 340.

If the setting for the manageable port 26 is enable, the SNMP program 3 goes ahead to processing of S214, and in any other case, proceeds to processing of S210.

At step 210 (S210), the port setting section 322 determines whether or not status information over time of the manageable port 26 stored in the setting-status DB 342 varies inappropriately or unstably (see condition (3) above).

If the status information varies inappropriately or unstably, the SNMP program 3 goes ahead to processing of S220, and in any other case, proceeds to processing of S212.

At step 212 (S212), the SNMP program 3 determines whether or not the setting and status respectively indicated by the setting information and status information returned from the network device 2 and the setting information and status information stored in the MIB information DB 340 and the setting-status DB 342 constitute a combination defined in advance by the user (see condition (4) above).

If it is the user-defined combination, the SNMP program 3 goes ahead to processing of S220, and in any other case, proceeds to processing of S214.

At step 214 (S214), the port setting section 322 determines whether or not there is any inconsistency between the setting of the manageable port 26 stored in the setting-status DB 342 and the setting on the manageable port 26 returned from the network device 2 (see condition (1) above).

More specifically, for instance, the port setting section 322 determines whether or not the setting on the manageable port 26 returned from the network device 2 is for disable (ifAdminStatus=DOWN).

If the setting on the port 26 is for disable, the SNMP program 3 goes ahead to processing of S220, and in any other case, proceeds to processing of S216.

At step 216 (S216), the port setting section 322 determines whether or not there is any inconsistency between the setting information on the manageable port 26 stored in the setting-status DB 342 and the status of the manageable port 26 indicated by the status information returned from the network device 2 (see condition (2) above).

More specifically, for instance, the port setting section 322 determines whether or not the port 26, according to the information stored in the setting-status DB 342, remains in a disabled or tested (ifoperStatus=DOWN/TEST) status without returning to an enabled (ifoperStatus=UP) status for a prescribed length of time.

If the port 26 is found to be not returning to an enabled status for the prescribed length of time, the SNMP program 3 goes ahead to processing of S220, and in any other case, proceeds to processing of S218.

At step 218 (S218), the SNMP program 3 determines that the manageable port 26 is operating normally, and ends processing.

At step 220 (S220), the port setting section 322 determines whether or not the manageable port 26 is in an abnormal state (a state which fits any of the conditions (1) through (4) above).

Further, the port setting section 322 manages, via the SNMP processing section 30, the network device 2 subject to management to disable the port 26 (port disabled).

[Overall Operation]

The overall operation of the network system 1 will be described below.

[Normal Operation]

First will be described its normal operation.

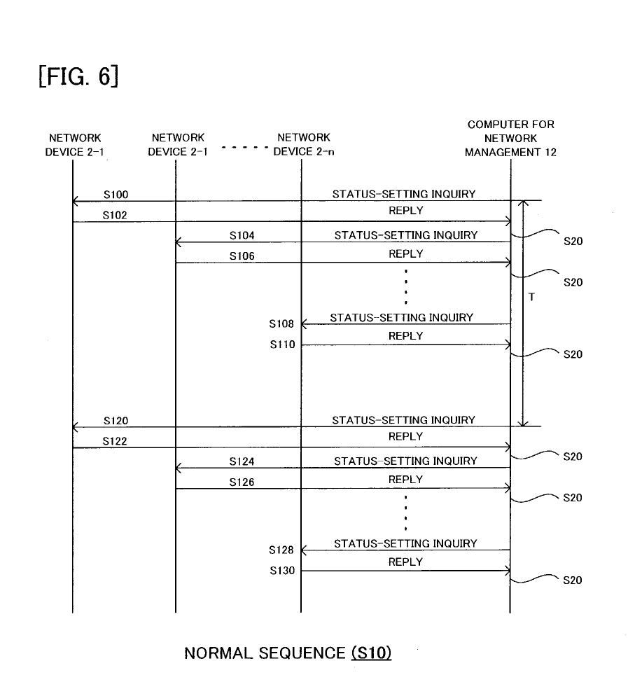

FIG. 6 illustrates a normal sequence (S10) when the setting-status of any port 26 is normal in the network system 1 shown in FIG. 1.

As shown in FIG. 6, for instance, the SNMP program 3 is actuated on the computer 12 at regular time intervals, and successively issues setting-status inquiries to the network devices 2-1 through 2-n (FIG. 1 and elsewhere) (Sl00, S104 and S108).

Having received one or another of these inquiries, each of the network devices 2-1 through 2-6 responds to the inquiry from the computer 12 (the SNMP program 3) by returning a reply containing status information and setting information on one or another of the ports 26 (S102, S106 and S110).

The computer 12 (the SNMP program 3), every time a reply comes back from a network device 2, performs the processing (S20) shown in FIG. 4 and, if none of the ports 26 fits any of the conditions (1) through (4) above, performs no particular setting for any of the network devices 2-1 through 2-n, and ends processing.

After the lapse of a prescribed length of time, the SNMP program 3 is actuated in the computer 12 to carry out processing of the steps S100 through S110 referred to above.

[Abnormal Operation]

Next will be described an abnormal operation.

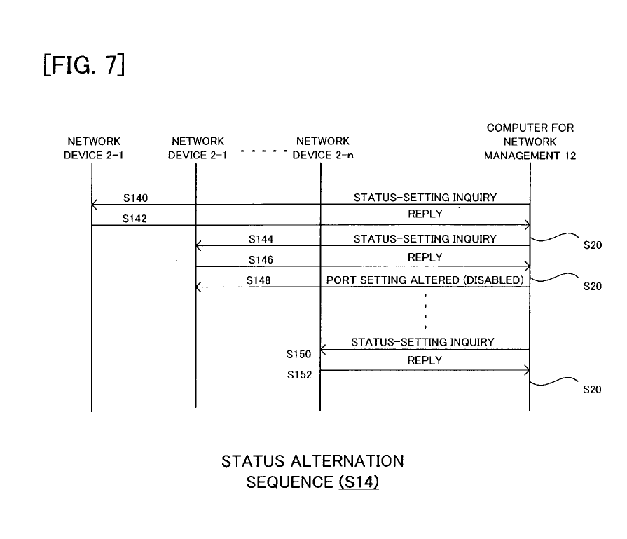

FIG. 7 illustrates an abnormal sequence (S14) when any abnormality has arisen in the setting-status of any of the ports 26 in the network system 1 shown in FIG. 1.

As shown in FIG. 7, for instance, the SNMP program 3 actuated on the computer 12 successively issues setting-status inquiries to the network devices 2-1 through 2-n (FIG. 1 and elsewhere) (S140, S144 and S150).

Having received one or another of these inquiries, each of the network devices 2-1 through 2-6 responds to the inquiry from the computer 12 (the SNMP program 3) by returning a reply containing status information and setting information on one or another of the ports 26 (S142, S146 and S152).

The computer 12 (the SNMP program 3), every time a reply comes back from a network device 2, performs the processing (S20) shown in FIG. 4 and, for instance, if any of the ports 26 of the network devices 2-1 fits any of the conditions (1) through (4) above, sets the network device 2-1 for disabling the port 26 found to fit one of the conditions (1) through (4) above.

As hitherto described, ports of network devices can be managed by an apparatus or a method for communication port management according to the present invention.

Also, any trouble arising from the setting of any unused port in a network device in an enabled status can be effectively prevented by the apparatus or the method for communication port management according to the invention.

The apparatus and the method for communication port management according to the invention can be used for the management of ports of network devices.

What is claimed is:

1. A communication port management apparatus for managing each of one or more communication ports which each of one or more communication units has, comprising:
information acquiring means for acquiring from each of the communication units first setting information indicating a setting for each of the communication ports and first status information indicating a status of each of the communication ports, or first communication unit information containing either of the foregoing,
information holding means for holding second setting information indicating a setting for each of the communication ports and first status information (second status information) contained in the acquired first communication unit information, or second communication unit information containing either of the foregoing, and
communication port managing means for managing each of the communication ports to be enabled or disabled on the basis of the acquired first communication unit information and the held second communication unit information.

2. The communication port management apparatus according to claim 1, wherein
the first communication unit information includes at least the first setting information, and the second communication unit information includes at least the second setting information,
the information acquiring means acquire from each of the communication units at least the first setting information,
the information holding means hold at least the second setting information, and
the communication port managing means disable any communication port on which the acquired first setting information and the held second setting information are inconsistent with each other.

3. The communication port management apparatus according to claim 2, wherein
the first setting information and the second setting information indicate whether each the communication port is enabled or disabled, and
the communication port managing means disable any communication port on which the acquired first setting information and the held second setting information are inconsistent with each other.

4. The communication port management apparatus according to claim 3, wherein
the communication port managing means disable any communication port on which the acquired first setting information indicates enable and the held first setting information indicates disable.

5. The communication port management apparatus according to any of claims 1 through 4, wherein
the first communication unit information includes at least the first status information, and the second communication unit information includes at least the second status information,
the information acquiring means acquire the first status information from each of the communication units,
the information holding means successively hold at least the acquired first status information as the second status information, and
the communication port managing means manage each of the communication ports to be enabled or disabled on the basis of variation over time of the second status information.

6. The communication port management apparatus according to claim 5, wherein
the first status information and the second status information indicate a status of use of each of the communication ports, and
the communication port managing means disable any communication port on which the second status information inappropriately varies.

7. The communication port management apparatus according to claim 6, wherein
statuses which can be indicated by the first status information and the second status information include a first status indicating that the communication ports are enabled, a second status indicating that the communication ports are disabled, and a third status indicating that the communication ports are being tested, and
the communication port managing means disable any communication port on which the second status information indicates an inappropriate transition among the first through third statuses.

8. The communication port management apparatus according to any of claims 1 through 7, wherein
the first communication unit information includes the first setting information and the first status information, and the second communication unit information includes at least the second status information,
the information acquiring means acquire the first setting information and the first status information from each of the communication units,
the information holding means successively hold at least the acquired first status information as the second status information, and
the communication port managing means manage each of the communication ports to be enabled or disabled on the basis of variation over time of the acquired first setting information and the second status information.

9. The communication port management apparatus according to claim 8, wherein
statuses which can be indicated by the first status information and the second status information include a first status indicating that the communication ports are enabled, a second status indicating that the communication ports are disabled, and a third status indicating that the communication ports are being tested, and
the communication port managing means disable any communication port on which the second status information indicates its being in the second or third status for a prescribed length of time or longer.

10. The communication port management apparatus according to any of claims 1 through 9, wherein
at least the first communication unit information, the acquisition of the first communication unit information by the information acquiring means, and the management of communication ports by the communication port managing means conform to the Simple Network Management Protocol (SNMP).

11. A communication port management method for managing each of one or more communication ports which each of one or more communication units has, whereby
first setting information indicating a setting for each of the communication ports and first status information indicating a status of each of the communication ports, or first communication unit information containing either of the foregoing is acquired from each of the communication units,
second setting information indicating a setting for each of the communication ports and first status information (second status information) contained in the acquired first communication unit information, or second communication unit information containing either of the foregoing is held, and
each of the communication ports is managed to be enabled or disabled on the basis of the acquired first communication unit information and the held second communication unit information.

12. The communication port management method according to claim 11, wherein
the first communication unit information includes at least the first setting information, and the second communication unit information includes at least the second setting information,
at least the first setting information is acquired from each of the communication units,
at least the second setting information is held, and
any communication port on which the acquired first setting information and the held second setting information are inconsistent with each other is disabled.

13. The communication port management method according to claim 11 or 12, wherein
the first communication unit information includes at least the first status information, and the second communication unit information includes at least the second status information,
the first status information is acquired from each of the communication units,
at least the acquired first status information is successively held as the second status information, and
each of the communication ports is managed to be enabled or disabled on the basis of variation over time of the second status information.

14. The communication port management method according to any of claims 11 through 13, wherein
the first communication unit information includes the first setting information and the first status information, and the second communication unit information includes at least the second status information,
the first setting information and the first status information are acquired from each of the communication units,
at least the acquired first status information is successively held as the second status information, and
each of the communication ports is managed to be enabled or disabled on the basis of variation over time of the acquired first setting information and the second status information.

15. A program for managing each of one or more communication ports which each of one or more communication units has, the program causing a computer to execute:
a step of acquiring first setting information indicating a setting for each of the communication ports, and first status information indicating a status of each of the communication ports, or first communication unit information containing either of the foregoing, from each of the communication units,
a step of holding second setting information indicating a setting for each of the communication ports, and first status information (second status information) contained in the acquired first communication unit information, or second communication unit information containing either of the foregoing, and
a step of managing each of the communication ports to be enabled or disabled on the basis of the acquired first communication unit information and the held second communication unit information.

16. The program according to claim 15, wherein
the first communication unit information includes at least the first setting information, and the second communication unit information includes at least the second setting information,
at least the first setting information is acquired from each of the communication units at the step of acquiring the first communication unit information,
at least the second setting information is held at the step of holding the second communication unit information, and
any communication port on which the acquired first setting information and the held second setting information are inconsistent with each other is disabled at the step of managing each of the communication ports to be enabled or disabled.

17. The program according to any of claim 15 or 16, wherein
the first communication unit information includes at least the first setting information, and the second communication unit information includes at least the second setting information,
the first status information is acquired from each of the communication units at the step of acquiring the first communication unit information,
at least the acquired first status information is successively held as the second status information at the step of holding the second communication unit information, and
each of the communication ports is managed to be enabled or disabled on the basis of variation over time of the second status information at the step of managing each of the communication ports to be enabled or disabled.

18. The program according to any of claims 15 through 17, wherein
the first communication unit information includes at least the first setting information, and the second communication unit information includes at least the second setting information,
the first setting information and the first status information are acquired from each of the communication units at the step of acquiring the first communication unit information,
at least the acquired first status information is successively held as the second status information at the step of holding the second communication unit information, and
each of the communication ports is managed to be enabled or disabled on the basis of variation over time of the acquired first setting information and the second status information at the step of managing each of the communication ports to be enabled or disabled.
